(19) United States
(12) Patent Application Publication
(10) Pub. No.: US 2022/0041420 A1
(43) Pub. Date: Feb. 10, 2022

(54) PORTABLE PLATFORM AND STEP ASSEMBLY FOR USE WITH A VEHICLE

(71) Applicant: Keven Decker, Effingham, SC (US)

(72) Inventor: Keven Decker, Effingham, SC (US)

(21) Appl. No.: 17/397,814

(22) Filed: Aug. 9, 2021

Related U.S. Application Data
(60) Provisional application No. 63/063,373, filed on Aug. 9, 2020.

(51) Int. Cl. B66F 11/04; B66F 7/06; A01M 31/02

(52) U.S. Cl. CPC B66F 11/04; A01M 31/02; B66F 7/0691

(57) ABSTRACT

A platform assembly for a vehicle includes a platform, a first frame section mounted to the platform and a second frame section rotatably mounted to the platform. The first frame section is pivotably mountable to an elevated structure in the vehicle such as a roll bar. When installed in a vehicle, the platform assembly is easily stowed for storage by rotating the first frame section to a generally horizontal position, which causes the platform to extend downward into the vehicle's cargo area. The platform assembly is easily movable to an extended position for use by rotating the first frame section and the platform together until the platform is elevated and horizontal. The second frame section can then be rotated until it contacts the vehicle to further support the platform.

### CROSS-REFERENCE TO RELATED APPLICATION

This application claims the benefit of U.S. Provisional Patent Application No. 63/063,373, filed Aug. 9, 2020, and which is hereby incorporated by reference in its entirety.

### TECHNICAL FIELD

This disclosure relates to elevatable platforms.

### BACKGROUND

An elevated platform is often desired in various situations. For example, hunting stands are often employed to support a hunter on a platform in an elevated position relative to the ground. This elevated position of the hunter provides the hunter with a wider field of vision and wider range in which to view and harvest game animals. The elevated position provided by a hunting stand also places the hunter outside the field of vision of most game animals, and therefore helps to conceal the hunter.

In order to safely support a hunter, hunting stands must have adequate structure to bear the weight of the hunter. Some hunting stands are placed in trees, with the tree providing the necessary structural support. Other hunting stands are free-standing, permanent or semi-permanent structures that include a frame that supports the platform above the ground.

### SUMMARY

A platform assembly for use with a vehicle having a cab and a cargo area is provided. The platform assembly includes a platform, a first frame section, and a second frame section. The first frame section is mounted to the platform and is rotatably mountable with respect to the structure of the vehicle, e.g., structure above the cab. The second frame section is rotatably mounted to the platform. The hunting stand assembly is configured such that, when the first frame section is rotatably mounted with respect to the cab, the hunting stand assembly is selectively movable between a stowed configuration and an extended configuration.

In the stowed configuration, the first frame section is generally horizontal (i.e., more horizontal than vertical), the platform extends generally downward into the cargo box, and the second frame section extends generally rearward. In the extended configuration, the first frame section is generally vertical, the platform is substantially horizontal, and the second frame section is generally vertical and contacts the floor of the cargo box.

The hunting stand assembly is easy to transport to a hunting location on an all terrain vehicle, and provides rapid and easy deployment compared to prior art hunting stands. The hunting stand assembly uses, in part, the structure of the vehicle to support the platform at an elevated height, and thus the reduces the weight and complexity compared to prior art hunting stands.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, side view of a platform assembly in accordance with the claimed invention operatively connected to an all terrain vehicle and in a stowed position or configuration;

FIG. 2 is a schematic, rear view of the platform assembly in an extended position or configuration;

FIG. 3 is a schematic, side view of the platform assembly in the extended position or configuration;

FIG. 4 is a schematic, front view of a pivot joint used in the platform assembly;

FIG. 5 is a schematic, side view of the pivot joint of FIG. 4;

FIG. 6 is a schematic, side view of another pivot joint used in the platform assembly;

FIG. 7 is a schematic, rear view of the pivot joint of FIG. 6;

FIG. 8 is a schematic, front view of a step assembly in an intermediate configuration between a compact configuration and an extended configuration;

FIG. 9 is a schematic, front view of the step assembly of FIG. 8 in the extended configuration;

FIG. 10 is a schematic, side view of the step assembly the extended position;

FIG. 11 is a schematic, front view of the step assembly mounted to the bed of the vehicle and in the compact configuration; and

FIG. 12 is a schematic, side view of the step assembly in the compact configuration.

### DESCRIPTION OF THE PREFERRED EMBODIMENTS

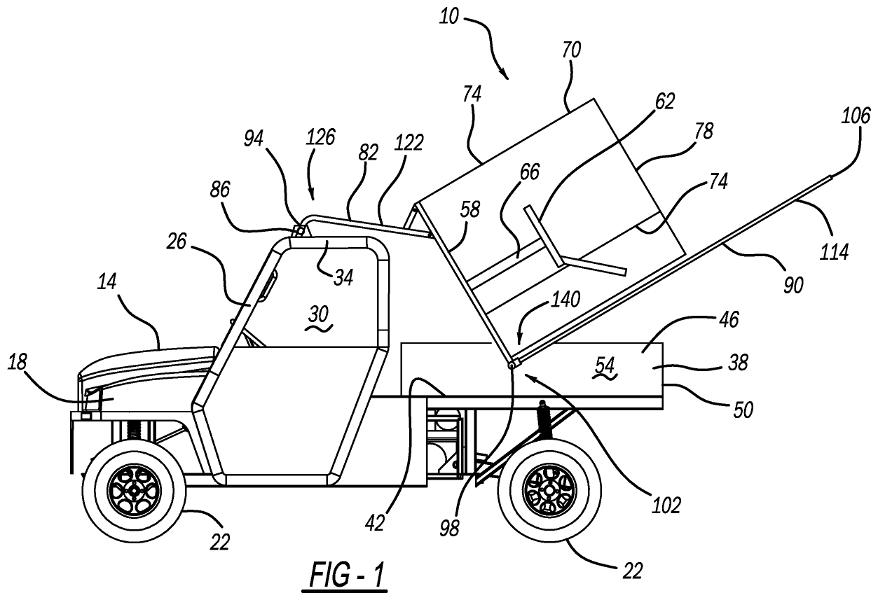

Referring to FIGS. 1-4, wherein like reference numbers refer to like components, a portable platform assembly 10, also referred to herein as a “hunting stand assembly,” for use with an all-terrain vehicle 14 is schematically depicted. It should be noted that, although the platform assembly 10 shown is intended for use as a hunting stand, other uses and configurations may be employed within the scope of the claimed invention. For example, and within the scope of the claimed invention, the platform assembly 10 may be employed for use in construction, building maintenance, etc., to reach elevated places instead of using a ladder or scaffolding.

The all-terrain vehicle 14 includes a body 18 operatively connected to ground-engaging wheels 22. As understood by those skilled in the art, the vehicle 14 includes a powertrain system (not shown) configured to propel the vehicle, as well as a steering system (not shown) and braking system (not shown).

The body 18 includes a cab portion 26 that defines a passenger area or passenger compartment 30. In the embodiment depicted, the cab portion 26 includes a substantially horizontal panel that forms the roof 34 of the passenger compartment 30. The body 18 may also include doors, windows, a windshield, etc. that further define the passenger area or passenger compartment 30. The body 18 also includes a cargo area or cargo portion 38 positioned behind the cab portion 26. The cargo portion 38 includes a cargo box having a cargo floor 42, two side panels 46, and a tailgate 50. The floor 42, panels 46, and tailgate 50 cooperate to define a cargo space 54 that is open and unobstructed at its top, as understood by those skilled in the art.

The hunting stand assembly 10 includes a platform 58. A seat 62 is connected to the platform 58 via a support member 66. Fencing 70 includes rails 74 mounted to the periphery of the platform 58 and extending substantially perpendicularly from the platform 58 on the same side of the platform 58 as the seat 62 and support member 66. The fencing 70 also includes a rail 78 that interconnects the rails 74.

The hunting stand assembly 10 includes a first frame section 82 that is mounted to the platform 58 and is pivotably mounted with respect to the roof 34 for rotation about a first axis 94. The first frame section 82 is pivotably mounted to structure that extends over the passenger area 30. In the embodiment depicted, the structure to which the first frame section 82 is pivotably mounted is a roll bar 86 of the vehicle 18 that extends above the roof 34.

The platform 58, the seat 62 and support 66, and the fencing 70 are all connected to the first frame section 82 for unitary movement therewith. Accordingly, rotation of the first frame section 82 about the first axis 94 also causes the platform 58, seat 62, and fencing 70 to rotate about the first axis 94.

The hunting stand 10 also includes a second frame section 90 that is pivotably connected to the platform 58 such that the second frame section 90 is pivotable or rotatable with respect to the platform 58 about a second axis 98. More specifically, the second frame section 90 has a first end 102 and a second end 106. The first end 102 is at or adjacent to the second axis 98. The first and second axes 94, 98 are substantially horizontal, parallel to one another, and extend transversely relative to the vehicle 14.

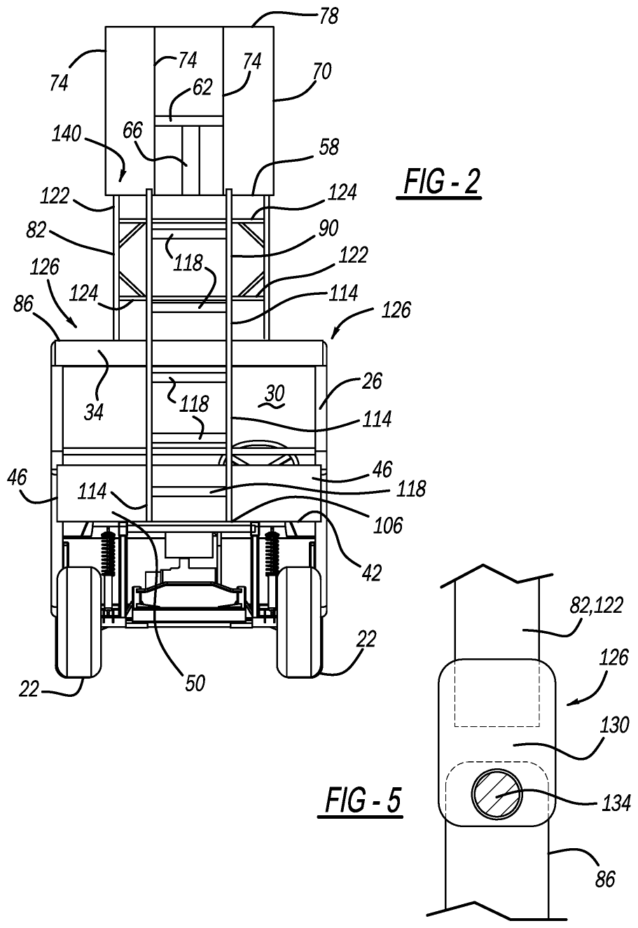

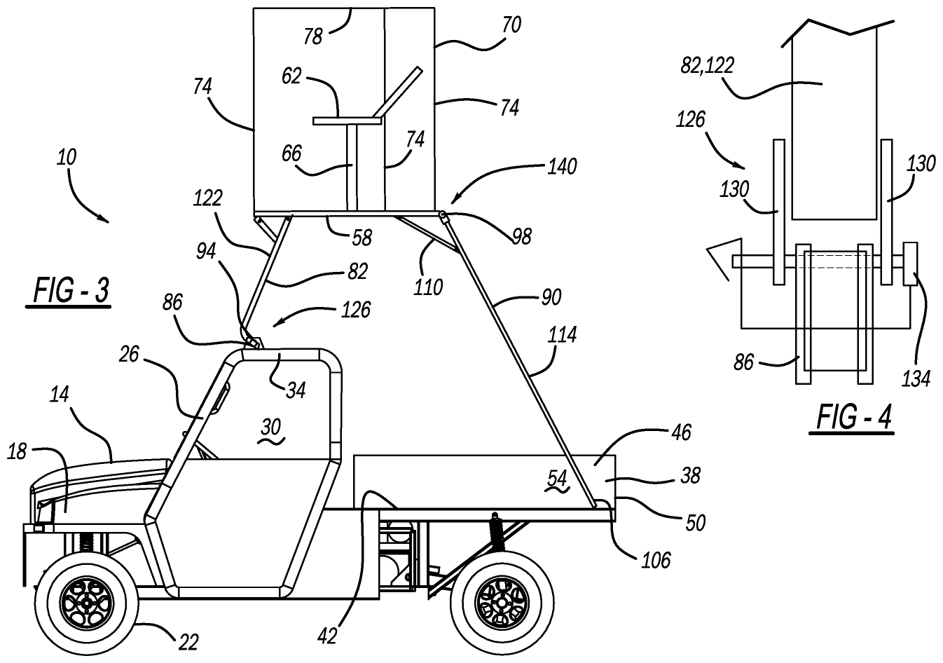

The hunting stand assembly 10 is movable between a stowed position, as shown in FIG. 1, and an extended position, as shown in FIGS. 2 and 3. Referring specifically to FIG. 1, in the stowed position, the first frame section 82 is substantially horizontally oriented and substantially parallel with the roof 34. In the embodiment depicted, the pivot axis 94 of the first frame section 82 is near or adjacent the forward end of the roof 23, and thus the first frame section 82 extends over most of the roof 34 when the assembly 10 is in the stowed configuration.

Further, when the hunting stand assembly 10 is in the stowed configuration, the platform 58 is generally vertically oriented and extends downwardly from the first frame section 82 into the cargo space 54 of the cargo box. In the stowed configuration, the second frame section 90 extends generally perpendicularly from the platform 58 in a generally rearward direction relative to the body 18 of the vehicle 14 and extends on the same side of the platform 58 as the seat 62 and support member 66.

Referring to FIGS. 1-3, a method of moving the hunting stand assembly 10 from the stowed position, as shown in FIG. 1, to the extended position, as shown in FIGS. 2 and 3, includes rotating or pivoting the first frame section 82 relative to the body 18 about the first axis 94 until the first frame section 82 is generally vertically oriented (i.e., more vertical than horizontal) and the platform 58 is substantially horizontal, as shown in FIGS. 2 and 3. In the embodiment depicted, the platform 58 is substantially parallel to the roof 34 when the hunting stand assembly 10 is in the extended configuration.

The method further includes rotating or pivoting the second frame section 90 relative to the platform 58 about the second axis 98 until the second end 106 of the second frame section 90 contacts the floor 42 of the cargo box as shown in FIGS. 2 and 3. In the embodiment depicted, the second frame section 90 is rotated almost 180 degrees relative to the platform 58, and, thus, the second frame section 90 extends on the side of the platform 58 opposite the seat 62.

When the hunting stand assembly 10 is in the extended position, the first frame section 82 and the second frame section 90 cooperate to support the platform 58 in the elevated, horizontal position as shown. A brace member 110 is connected to the platform 58 and the second frame section 90, such as via bolts or threaded fasteners, after the hunting stand assembly 10 is in its extended configuration such that the brace member 110 locks the second frame section 90 relative to the platform 58, thereby maintaining the hunting stand assembly 10 in the extended configuration.

Referring specifically to FIGS. 2 and 3, when the hunting stand assembly 10 is in the extended configuration, the platform 58 is elevated above the roof 34 in a horizontal orientation, thereby enabling a hunter to be supported on the platform 58 during hunting. The seat 62 is supported above the platform 58 by the support member 66, thereby providing a place for the hunter to sit. The fencing 70 is positioned to surround the hunter on the platform. The placement of the first axis 94 above the cab 26 enables the structure of the cab to support the frame section 82 and platform 58, thereby enabling the frame section 82 to be significantly shorter than frame section 90. Thus, the platform assembly 10 takes advantage of the pre-existing structure of the vehicle 10.

As best seen in FIG. 2, the second frame section 90 includes two elongated members 114 that are parallel to one another and that extend generally vertically when the hunting stand assembly 10 is in the extended position. The frame section 90 further includes a plurality of step members 118 that interconnect, and extend between, the elongated members 114. The second frame section 90 thus functions as a ladder to enable a hunter to climb to the platform 58.

The first frame section 82 may have a variety of different configurations within the scope of the claimed invention. In the embodiment depicted, the first frame section 82 includes two rails 122 that are parallel to one another and that extend between the first axis 94 and the platform 58. The first frame section 82 also includes a plurality of cross-members 124 that interconnect the rails 118. Other braces may be included as shown in the Figures.

Pivot joints 126 rotatably connect the roll bar 86 and the first frame section 80, and, more specifically, rotatably connect each of the rails 122 to the roll bar 86. Referring to FIGS. 4 and 5, wherein like reference numbers refer to like components from FIGS. 1-3, each pivot joint 126 includes two plates 130 that are welded or otherwise attached to one of the rails 122. A pin 134 extends through holes in the plates 130 and the roll bar 86, thereby rotatably connecting the first frame section 80 to the roll bar 86. The first axis 94 of rotation extends through the pin 134.

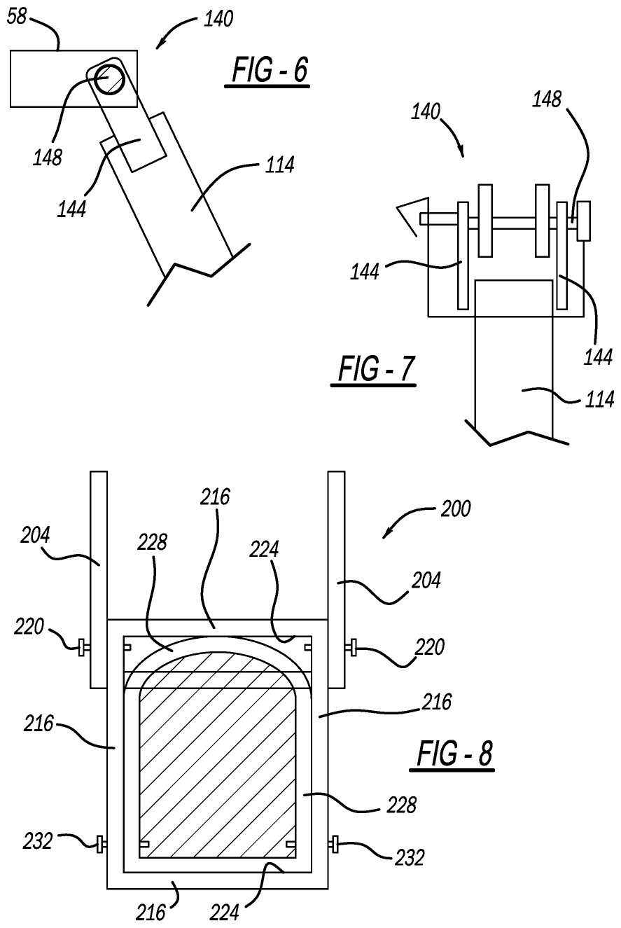

Similarly, pivot joints 140 rotatably interconnect the second frame section 90 and the platform. Referring to FIGS. 7 and 8, wherein like reference numbers refer to like components from FIGS. 1-6, each pivot joint 140 includes two plates 144 that are welded or otherwise connected to one of the members 114. A pivot pin 148 extends through holes in the plates 144 and the platform 58. The second axis 98 extends through the pin 148.

As used herein, terms denoting direction and orientation, such as horizontal, vertical, up, down, etc., refer to direction and orientation when the vehicle 14 is resting on a level surface.

It should be noted that the hunting stand assembly 10 may be used and marketed for activities not related to hunting within the scope of the claimed invention. For example, and without limitation, the hunting stand assembly 10 may be employed and marketed for home improvement and repair, such as power washing second story homes and reaching gutters for cleaning. In one embodiment, the seat 62 and support member 66 are selectively detachable from the platform 58 to accommodate other uses.

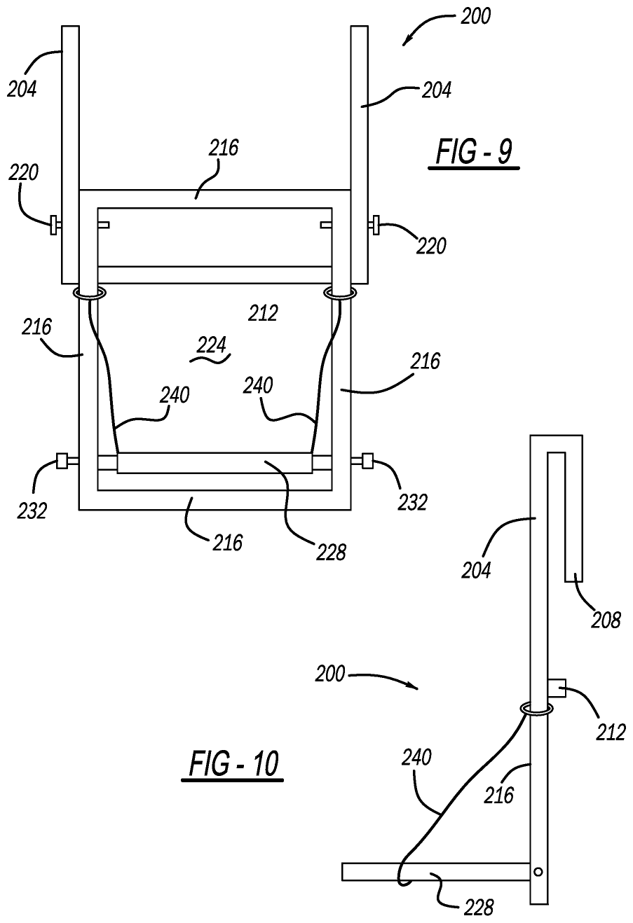

FIGS. 8-12, wherein like reference numbers refer to like components from FIGS. 1-8, schematically depict a step assembly 200 for use with the vehicle 14. Referring to FIGS. 8-12, the step assembly 200 includes two members 204 spaced a distance apart from one another and each defining a respective hook 208. The two members 204 are parallel to one another, and interconnected by member 212, which extends perpendicularly therebetween. The step assembly 200 also includes a rectangular frame section 216 that is fittable between the two members 204 and that is rotatably connected between the members via pivot pins 220. The rectangular frame section 216 defines a rectangular open space 224. A step member 228 is fittable inside the open space 224 and is pivotably connected to the frame section 216 via pivot pins 232. Thus, the frame section 216 is pivotable with respect to the members 204, and the step member 228 is pivotable with respect to the frame section 216.

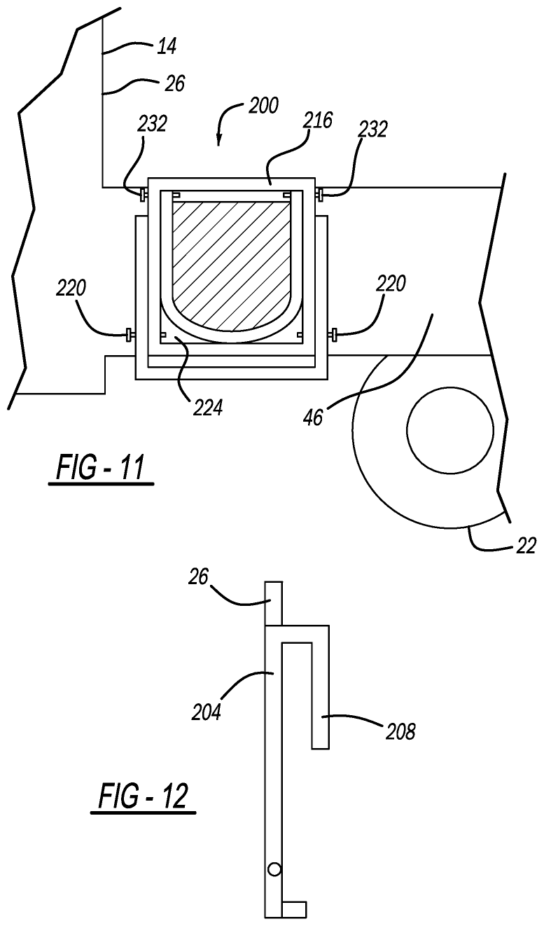

The hooks 208 are engageable with the side panels 46 of the vehicle 14 to suspend the step assembly 200 therefrom, as best shown in FIG. 11. Referring to FIG. 11, the step assembly is in a compact configuration in which the frame section 216 is mostly contained between the two members 204 and the step member 228 is mostly contained within the open space 224 of the frame section 216.

To move the step assembly 200 from the compact configuration to an extended position for use, the frame section 216 (with the step member 228 therein) is rotated about the pivot pins 220 approximately 180 degrees relative to the two members 204 so that the frame section 216 extends lower than in the compact configuration, as shown in FIG. 8. Then, the step member 228 is rotated about pivot pins 232 approximately 90 degrees relative to the frame section 216 so that the step member 228 is substantially horizontal for use as a step to access the cargo area of the vehicle 14. Cables 240 interconnect the frame section 216 and the step member 228 to prevent overextension of the step member.

While the best modes for carrying out the invention have been described in detail, those familiar with the art to which this invention relates will recognize various alternative designs and embodiments for practicing the invention within the scope of the appended claims.

1. An apparatus for use with a vehicle having a cab with a roof and a cargo floor, the apparatus comprising:
a platform;
a first frame section being mounted to the platform and rotatably mountable with respect to the roof; and
a second frame section being rotatably mounted to the platform.

2. The apparatus of claim 1, wherein the second frame section includes a plurality of step members to form a ladder.

3. The apparatus of claim 2, wherein the first frame section is shorter than the second frame section.

4. The apparatus of claim 3, further comprising a seat mounted to the platform.

5. The apparatus of claim 4, further comprising fencing mounted to the platform.

6. The apparatus of claim 1, wherein said apparatus is configured such that, when the first frame section is rotatably mounted with respect to the roof, the apparatus is selectively movable between a stowed configuration and an extended configuration;
wherein the first frame section is generally horizontal, the platform extends generally downward into the cargo box, and the second frame section extends generally rearward when the apparatus is in the stowed configuration; and
wherein the first frame section is generally vertical, the platform is substantially horizontal, and the second frame section is generally vertical and contacts the cargo floor when the apparatus is in the extended configuration.

7. A vehicle comprising:
a body defining a passenger area and a cargo floor behind the passenger area;
structure extending above the passenger area;
a platform assembly having a first frame section, a platform, and a second frame section;
said first frame section being rotatably mounted to the structure such that the first frame section is selectively rotatable relative to the body about a first axis;
said platform being mounted to the first frame section; and
said second frame section being rotatably mounted to the platform such that the second frame section is selectively rotatable relative to the platform about a second axis.

8. The vehicle of claim 7, wherein the first axis and the second axis are substantially parallel to each other.

9. The vehicle of claim 7, wherein the platform assembly is selectively movable between a stowed configuration and an extended configuration;
wherein the first frame section is generally horizontal, the platform extends generally downward behind the passenger area, and the second frame section extends generally rearward when the platform assembly is in the stowed configuration; and
wherein the first frame section is generally vertical, the platform is substantially horizontal, and the second frame section is generally vertical and contacts the cargo floor when the platform assembly is in the extended configuration.

10. The vehicle of claim 9, further comprising a seat mounted to the platform.

11. A method comprising:
possessing a vehicle with a body defining a passenger area with structure above the passenger area and a cargo floor behind the passenger area;
said vehicle having a platform assembly with a first frame section rotatably connected to the structure and pivotable relative to the body about a first axis, a platform mounted to the first frame section, and a second frame section rotatably connected to the platform and pivotable relative to the platform about a second axis;
moving the platform assembly from a stowed configuration to an extended configuration.

12. The method of claim 11, wherein said moving the platform assembly from a stowed configuration to an extended configuration includes rotating the platform and the first frame section about the first axis thereby to elevate the platform such that the platform is substantially horizontal.

13. The method of claim 12, wherein said moving the platform assembly from a stowed configuration to an extended configuration further includes rotating the second frame section about the second axis until the second frame section is generally vertical and one end of the second frame section is supported by the vehicle.
